(19) United States
(12) Patent Application Publication
(10) Pub. No.: US 2003/0176308 A1
(43) Pub. Date: Sep. 18, 2003

(54) Detergent compositions containing components modified to float in water

(75) Inventors: Isaac Israel Secemski, Teaneck, NJ (US); John Richard Nicholson, Ramsey, NJ (US); David John Lang, Ossining, NY (US)

Correspondence Address: UNILEVER, PATENT DEPARTMENT, 45 RIVER ROAD, EDGEWATER, NJ, 07020, US

(73) Assignee: Unilever Home & Personal USA

(21) Appl. No.: 10/098,876

(22) Filed: Mar. 14, 2002

(51) Int. Cl. C11D 17/00

(52) U.S. Cl. 510/445; 510/447

(57) ABSTRACT

Modified bleaching agents and enzymes for detergent compositions are described. The modified bleaching agents and enzymes have a wax clad and detergent compositions having the modified bleaching agents and enzymes display superior cleaning benefits.

### FIELD OF THE INVENTION

The present invention relates to detergent compositions. More particularly, the present invention is directed to machine dishwashing compositions comprising components having poor solubility in water. The components are modified to avoid mechanical loss of the same during a dishwashing process.

### BACKGROUND OF THE INVENTION

A variety of selected solid materials, which are poorly soluble in water and are denser than typical dishwashing wash water, are conventionally used as components in machine dishwashing compositions. Such materials include, for example, bleaching agents such as peracids, peracid precursors, bleach catalysts, and enzymes.

It is has been discovered that when such selected solid materials are incorporated in machine dishwashing compositions, poor cleaning performances can result, especially in short wash cycles and in low wash temperatures. These poor cleaning performances are typically pronounced when employing, for example, bleaching components. Particularly, it has been found that such poorly soluble materials (which can be particles or granules) sink into parts of a dishwashing machine where there is little water circulation, and they are flushed out of wash cycles without providing their characteristic benefits to the washing process.

It is of increasing interest to develop a methodology to modify solid materials that are of poor solubility in water and typically used in a dishwashing process so that they are not flushed out after the wash cycle without performing their expected function. It is especially desirable to develop such modified particles without lengthening their release time into the wash cycle. This invention, therefore, is directed to detergent compositions having materials that are poorly soluble in water at temperatures below about 40° C. and modified to float in the same. The modified materials comprise, among other things, less than about 20.0% by weight clad to thereby ensure that their release times into the dishwashing process are not affected by the modification, thereby resulting in superior cleaning benefits.

### ADDITIONAL INFORMATION

Efforts have been disclosed for making detergent compositions. In WO 01/59057, detergent compositions in tablet form are described and the tablet remains suspended in water upon contact.

In WO 02/10330 A1, dishwashing compositions comprising floating particles are disclosed.

None of the information above describes a dishwashing composition comprising poorly water soluble solid materials that have been modified to float in water with less than about 20.0% by weight of a clad.

### SUMMARY OF THE INVENTION

In a first aspect, the present invention is directed to a detergent composition comprising at least one particle with:

(a) a core which is poorly soluble in water and which has a density greater than about 1 g/cc; and

(b) a clad surrounding the core the clad having a density of less than about 1 g/cc,

wherein the clad makes up from about 0.01% to less than about 20.0% by weight of the particle and the core has an approximate diameter from about 50.0 to about 5000 microns.

In a second aspect, the present invention is directed to a method for washing dishware with the detergent composition of the first aspect of this invention.

Poorly soluble, as used herein, is defined to mean that when 0.5 g of core material is added to 50 ml of distilled water at 40° C. in a stoppered vessel, over about 75% of the core material remains undissolved after the stoppered vessel is inverted about five times. Core, as used herein, is defined to mean a center having at least one particle, granule, or combination thereof. Clad is defined to mean an encapsulant or coating suitable to cover a core. Approximate diameter is defined to mean the diameter of a core which is not a perfect sphere. Kitchenware is meant to mean any item typically washed in a dishwasher, like a glass, plate, pot, cup, knife, spoon or fork.

### DESCRIPTION OF THE PREFERRED EMBODIMENTS

There is no limitation with respect to the type of particle having a core and clad used in this invention, other than that the particle can be used in a detergent composition like a machine dishwashing composition. The core of the particle, however, preferably has a density of greater than about 1 g/cc and such a core typically comprises bleaching agents (i.e., bleach, bleach precursor or bleach catalyst, or mixtures thereof) or enzymes.

The bleaches which may be used in this invention include any of those which may be used in a detergent composition, and especially a dishwashing composition.

Illustrative bleaches useful herein include:

Alkyl peroxy acids and aryl peroxy acids such as:

peroxybenzoic acid and ring-substituted peroxybenzoic acids, like peroxy-α-naphthoic acid, and magnesium monoperoxyphthalate;

aliphatic and substituted aliphatic monoperoxy acids, like peroxylauric acid, peroxystearic acid, ε-phthalimidoperoxyhexanoic acid and o-carboxybenzamido peroxyhexanoic acid, N-nonylamidoperadipic acid and N-nonylamidopersuccinic acid;

cationic peroxy acids such as those described in U.S. Pat. Nos. 5,422,028, 5,294,362; and 5,292,447;

sulfonyl peroxyacids like the compounds described in U.S. Pat. No. 5,039,447 (Monsanto Co.).

Additional bleaches useful herein include:

diperoxy acids including alkyl diperoxy acids and aryl diperoxy acids such as:

1,12-diperoxydodecanedioic acid;

1,9-diperoxyazelaic acid;

diperoxybrassylic acid; diperoxysecacic acid, diperoxy-isophthalic acid;

2-decyldiperoxybutan-1,4-dioic acid;

N,N′-terephthaloyl-di(6-aminopercaproic acid); and

diacyl peroxides such as dibenzoylperoxide.

Other bleaches which may be employed in the present invention include inorganic peroxygen compounds. Illustrative examples of these compounds include monopersulfate (available commercially as the trisalt Oxone® from Dupont Chem. Co.), perborate monohydrate, perborate tetrahydrate, percarbonate, pyrophosphate peroxyhydrate, urea peroxyhydrate, sodium peroxide and mixtures thereof.

The especially preferred bleach employed in the present invention is ε-phthalimidoperoxyhexanoic acid (PAP) or o-carboxybenzamidoperoxyhexanoic acid, and mixtures thereof.

Bleach precursors suitable for use in this invention are polyacylated alkylene diamines, such as N,N,N′,N′-tetraacetylethylene diamine (TAED) and N,N,N′,N′-tetraacetylmethylene diamine (TAMD); acylated glycolurils, such as tetraacetylglycoluril (TAGU); xylose tetraacetate, glucose pentaacetate, triacetylcyanurate, sodium sulfophenyl ethyl carbonic acid ester, sodium acetyloxybenene sulfonate (SABS), sodium nonanoyloxy benzene sulfonate (SNOBS) and choline sulfophenyl carbonate. Other bleach precursors which may be used include phenylbenzoate, p-nitrophenyl benzoate, o-nitrophenyl benzoate, o-carboxyphenyl benzoate, p-bromophenylbenzoate, sodium or potassium benzoyloxy benzenesulfonate, benzoic anhydride, as well as benzoxazin derivatives.

Even other bleach precursors which may be used in this invention include (6-octanamido-caproyl)oxybenzenesulfonate, (6-nonanamido-caproyl)oxybenzenesulfonate, (6-decanamido-caproyl)oxybenzenesulfonate, valerolactams, and acyl caprolactams as well as cationic nitriles which react with an active oxygen source to give perimidic acids. Suitable cationic nitriles include N-methyl morpholinium acetonitrile, sold by BASF under the tradename Sokalan BM G, and disclosed in WO 96/40661, and the cationic nitriles disclosed in EP 303 520 B1, especially trimethylammonium nitrile quat.

In an especially preferred embodiment, however, the bleach precursors used in this invention are sodium p-benzoyloxybenzene sulfonate, N,N,N′,N′-tetraacetylethylene diamine, sodium nonanoyloxybenzene sulfonate, choline sulfophenyl carbonate, N-methyl morpholinium acetonitrile, trimethylammonium nitrile quat or mixtures thereof.

The bleach catalysts which may be used in this invention include transition metal bleach catalysts, and especially, those having manganese, iron, cobalt, titanium, molybdenum, nickel, chromium, copper, ruthenium, tungsten and mixtures thereof. These catalysts include simple water-soluble salts such as those of iron, manganese and cobalt as well as catalysts containing complex ligands.

Suitable examples of catalysts are described in U.S. Pat. No. 4,728,455, U.S. Pat. Nos. 5,114,606, 5,153,161, 5,194,416, 5,227,084, 5,244,594, 5,246,612, 5,246,621, 5,256,779, 5,274,147, 5,280,117 and European Pat. App. Pub. Nos. 544,440, 544,490, 549,271 and 549,272. Preferred examples of these catalysts include Mn^{IV}₂(u-O)₂(1,4,7-trimethyl-1,4,7-triazacyclononane)₂(PF₆)₂, Mn^{III}₂(u-O)₁(u-OAc)₂(1,4,7-trimethyl-1,4,7-triazacyclononane)₂(ClO₄)₂, Mn^{IV}₄(u-O)₆(1,4,7-triazacyclononane)₄ (ClO₄)₄, Mn^{III}Mn^{IV}₄(u-O)₁(u-OAc)₂(1,4,7-trimethyl-1,4,7triazacyclononane)₂(ClO₄)₃, Mn^{IV}(1,4,7-trimethyl-1,4,7-triazacyclononane)-(OCH₃)₃(PF₆), and mixtures thereof.

Iron and manganese salts of aminocarboxylic acids in general are useful herein including iron and manganese aminocarboxylate salts disclosed for bleaching in the photographic color processing arts. A particularly useful transition metal salt is derived from ethylenediaminedisuccinate and any complex of this ligand with iron or manganese.

Another class of catalysts includes those disclosed in U.S. Pat. No. 5,114,606. These catalysts are water soluble complexes of manganese (II), (III), and/or (IV) with a ligand which is a non-carboxylate polyhydroxy compound having at least three consecutive C-OH groups. Preferred ligands include sorbitol, iditol, dulsitol, mannitol, xylithol, arabitol, adonitol, meso-erythritol, meso-inositol, lactose and mixtures thereof. Especially preferred is sorbitol.

Other bleach catalysts which may be used in this invention include those comprising a complex of transition metals, including manganese, cobalt, iron or copper with a non-(macro)-cyclic ligand. Those comprising Mn gluconate, Mn(CF₃SO₃)₂, and binuclear Mn complexed with tetra-N-dentate and bi-N-dentate ligands, including [bipy₂Mn^{III}(u-O)₂Mn^{IV}bipy₂]-(ClO₄)₃ may also be employed.

Still other bleach catalysts which may be used are described, for example, in European Pat. App. Pub. Nos. 408,131 (cobalt complexes), 384,503 and 306,089 (metallo-porphyrins), U.S. Pat. No. 4,728,455 (manganese/multidenate ligand), U.S. Pat. No. 4,711,748 (absorbed manganese on aluminosilicate), U.S. Pat. No. 4,601,845 (aluminosilicate support with manganese, zinc or magnesium salt), U.S. Pat. No. 4,626,373 (manganese/ligand), U.S. Pat. No. 4,119,557 (ferric complex), U.S. Pat. No. 4,430,243 (Chelants with manganese cations and non-catalytic metal cations), and U.S. Pat. No. 4,728,455 (manganese gluconates).

Useful catalysts based on cobalt are described in Pat. App. Pub. Nos. WO 96123859, WO 96/23860 and WO 96/23861, and U.S. Pat. Nos. 5,559,261 and 5,703,030. WO 96/23860, for example, describes cobalt catalysts of the type [CoₙLₘXₚ]^{Z}Y_{Z}, where L is an organic ligand molecule containing more than one heteroatom selected from N, P, O and S; X is a co-ordinating species; n is preferably 1 or 2; m is preferably 1 to 5; p is preferably 0 to 4 and Y is a counterion. One example of such a catalyst is N,N′-Bis(salicylidene)ethylenediaminecobalt (II). Other cobalt catalysts described in these applications are based on Co(III) complexes with ammonia and mon-, bi-, tri- and tetradentate ligands such as [Co(NH₃)₅OAc]²⁺ with Cl⁻, OAc⁻, PF₆⁻, SO₄⁼, BF₄⁻ anions.

Organic bleach catalysts can also be used. These include sulfonimines as described in U.S. Pat. Nos. 5,041,232; 5,047,163 and 5,463,115, and quaternary imine salts, such as N-methyl-3,4-dihydroisoquinolinium p-toluenesulfonate as described in U.S. Pat. Nos. 5,360,568 and 5,370,826. For machine dishwashing use, the oxygen source used with quaternary imine salts is preferably potassium monopersulfate. Another class of organic bleach catalysts are the dioxiranes as have been disclosed in U.S. Pat. Nos. 5,755,993; 5,525,121 and 3,822,114.

Regarding the enzymes employable in this invention, such enzymes include proteases, amylases, lipases and cellulases. While compositions with single enzymes may be used it is highly preferred for machine dishwashing formulations to use combinations of two or more enzymes. Furthermore, since most machine dishwashing formulations contain oxidative bleaches, enzymes, especially amylases and proteases, which have been engineered for improved bleach stability, are highly preferred. Such engineering of enzymes is known (see for e.g. J. Biol. Chem. 260, 11, 1985, 6518-6521).

Examples of proteases which may make up the core of the present invention include Alcalase®, Savinase®, Ovozyme ®, Relase®, Neutrase® and Esperase® from Novo Industries A/S; Purafect ® OxP, and Properase®, ex. Genencor; and Maxatase® from International BioSynthetics Inc. Other examples of proteases include Protease A and Protease B as disclosed in European Patent Application 130,756 published Jan. 9 1985 and the proteases disclosed in U.S. Pat. Nos. 5,677,272 and 5,679,630. The proteases Ovozyme® and Savinase®) and Neutrase are preferred enzymes.

Examples of amylases include Termamyl® and Duramyl® from Novo Industries A/S; Purafect OxAm, from Genencor Int. and Rapidase® from International BioSynthetics Inc and amylases such as those described in British Patent Specification No. 1,296,839. The amylases Termamyl® and Duramyl® are preferred. Amylase variants produced by site directed mutagenesis of precursor amylases which are currently available and which have increased stability, relative to current references such as Termamyl® in one or more properties such as temperature stability, especially at wash temperatures of 45-75° C.; alkaline stability, especially at wash pH values of 8.5-11 and oxidative stability, especially in the presence of environments containing peracids, are especially preferred. Examples of such stability enhanced amylases are disclosed in WO/94/02597 wherein variants of precursor enzymes such as Termamyl® have been disclosed.

The use of lipase enzymes in detergent compositions, like machine dishwashing compositions is known in the art as disclosed in EP 271155. Commercial examples of lipases which may be used herein include Lipolase®—derived from Humicola lanuginosa—from Novo Industries A/S, Amano-CES from Toyo Jozo Co., Tagata, Japan, and lipases derived from Chromobacter viscosum available from U.S. Biochemical Corp., U.S.A and Diosynth Co., The Netherlands. Lipolase® and variants of lipases from Humicola lanuginosa as disclosed in WO92/05249 are preferred.

Cellulases such as those disclosed in U.S. Pat. No. 4,435,307, GB-A-2,075,028 and GB-A-2,095,275 may also be included in the instant invention. The commercially available Carezyme® from Novo Industries A/S is especially preferred.

As to the bleaching agents or enzymes that make up the core of the particle employed in this invention, such a core, again, has an approximate diameter from about 50 to about 5,000 microns, but preferably, from about 200 to about 4,500 microns, and most preferably, from about 300 to about 3,500 microns, including all ranges subsumed therein.

It is noted that when bleaching agents are employed in the core of the particles of this invention, they typically make up from about 0.1 to about 20.0%, and preferably, from about 2.0 to about 18.0%, and most preferably, from about 5.0 to about 15.0% by weight of the total weight of the detergent composition, including all ranges subsumed therein. Regarding enzymes in the core of the particles of this invention, they typically make up from about 0.1 to about 10.0%, and preferably, from about 0.2 to about 8.0%, and most preferably, from about 0.3 to about 6.0% by weight of the total weight of the detergent composition, including all ranges subsumed therein.

The clad for the bleaching agents or enzymes used in the detergent compositions of this invention is typically a wax, like a paraffin wax. Such paraffin waxes have low melting points, i.e., between about 40° C. and about 50° C. and a solids content of from about 35 to 100% at 40° C. and a solids content of from 0 to about 15% at 50° C. This melting point range for the clad material is desirable for several reasons. The minimum of 40° C. generally exceeds any typical storage temperatures that are encountered by cleaning compositions. Thus, the wax coat will protect the core throughout storage of the cleaning composition. The 50° C. melting point cap for the wax clad was selected as providing a wax which will quickly melt or soften early in any automatic dishwashing wash cycle. Melting or softening sufficient to release the core will occur because operating temperatures in automatic dishwashers are usually between 40° C. and 70° C. Thus, the paraffin waxes of the invention will release the core material when the capsule is exposed to the warmed wash bath, but not before. Paraffin waxes are selected over natural waxes for the subject invention because in liquid alkaline environments, natural waxes can hydrolyze and be unstable. Moreover, melted paraffin waxes of the encapsulated bleaches used in the invention will remain substantially molten at 40°-50° C. Such molten wax is easily emulsified by surfactant elements in cleaning compositions. Consequently, such waxes will leave less undesirable waxy residue on items to be cleaned than waxes with higher melting points.

Therefore, the wax coat preferably does not include any paraffins having a melting point substantially above 50° C., lest the higher melting point components remain solid throughout the wash cycle and form unsightly residues on surfaces to be cleaned nor any paraffins with solid contents discussed below.

The distribution of solids of the paraffin waxes of the invention ensures storage integrity of the encapsulated particles at temperatures up to 40° C. in either a liquid or moist environment while yielding good melting performance to release its active core during use at temperatures of about 50° C.

The amount of solids in a wax at any given temperature as well as the melting point range may be determined by measuring the latent heat of fusion of each wax by using Differential Scanning Calorimetry (DSC) by a process described in Miller, W. J. et al. Journal of American Oil Chemists' Society, July, 1969, V. 46, No. 7, pages 341-343, incorporated by reference. This procedure was modified as discussed below. DSC equipment used in the procedure is preferably the Perkin Elmer Thermoanalysis System 7 or the Dupont Instruments DSC 2910.

Specifically, the DSC is utilized to measure the total latent heat of fusion of multi-component systems which do not have a distinct melting point, but rather, melt over a temperature range. At an intermediate temperature within this range one is capable of determining the fraction of the latent heat required to reach that temperature. When acquired for a multi-component mixture of similar components such as commercial waxes, this fraction correlates directly to the liquid fraction of the mixture at that temperature. The solids fraction for the waxes of interest are then measured at 40° C. and 50° C. by running a DSC trace from −10° C. to 70° C. and measuring the fraction of the total latent heat of fusion required to reach these temperatures. A very low temperature ramping rate of 1° C./min should be used in the test to ensure that no shifting of the graph occurs due to temperature gradients within the sample.

The more solids present in a wax at room temperature, the more suitable the wax is for the present invention; this is because such solids strengthen the wax coating, rendering the particle less vulnerable to ambient moisture or a liquid aqueous environment, whereas “oil” or liquid wax softens the wax, opening up pores in the coating and thereby provides poorer protection for the core of the particle. Significant solid paraffin remaining at 50° C. may remain on the cleaned hard surfaces (e.g., dishware in an automatic dishwashing machine) and is undesirable.

Therefore, the wax solids content as measured by Differential Scanning Calorimetry for suitable paraffin waxes may range from 100 to about 35%, optimally from 100 to about 70%, at 40° C. and from 0 to about 15% and preferably 0 to about 5% at 50° C.

Bleaching agents or enzymes coated with micro-crystalline waxes would therefore have a poorer protective coating, and the wax coat which melts from such particles would be less likely to emulsify in cleaning compositions. Thus, micro-crystalline waxes are not considered within the operative scope of this invention.

Commercially available paraffin waxes which are suitable for encapsulating the core materials include Merck 7150 (54% solids content at 40° C. and 2% solids content at 50° C.) ex. E. Merck of Darmstadt, Germany; IGI Paraffin Wax 1397 (74% solids content at 40° C. and 0% solids content at 50° C.) and IGI Paraffin Wax 1538 (79% solids content at 40° C. and 0.1% solids content at 50° C. ex. The International Group, Inc. of Wayne, Pa.; and Ross fully refined paraffin wax 115/120 (36% solids content at 40° C. and 0% solids content at 50° C.) ex Frank D. Ross Co., Inc. of Jersey City, N.J. Most preferred is IGI Paraffin Wax 1397.

Mixtures of paraffin waxes with other organic materials such as polyvinyl ethers as described in U.S. Pat. Nos. 5,460,743 and 5,589,267 are also useful to make the clads of this invention.

When preparing the particles of the present invention, the clad is placed on the core via well known art recognized techniques which include spraying molten wax onto bleach or enzyme materials (as the case may be) in a fluidized bed. Preferred processes are described in U.S. Pat. Nos. 5,200,236 and 5,230,822.

As mentioned above, the clad typically makes up from about 0.01% to less than about 20.0% by weight of the particle, but preferably, from about 1.0% to about 18.0%, and most preferably, from about 2.0% to about 15.0% by weight of the particle, including all ranges subsumed therein.

In an especially preferred embodiment, the core of the particle of the present invention is substantially free (e.g., less than 2.0% by weight of the total weight of the core) of the material used to make the clad, and in a most especially preferred embodiment, the core is free of the material used to make the clad. In another especially preferred embodiment, the thickness of the clad is from about (0.01-0.15)r, and preferably, from about (0.01-0.12)r, and most preferably, from about (0.02-0.10)r, including all ranges subsumed therein, where r is the approximate core radius.

There is no limitation with respect to additives used in the detergent compositions of the present invention other than that the additives can be used in a detergent composition such as a dishwashing composition.

Typically, the detergent compositions of the present invention comprise, in addition to the particles described above:

(a) an anti-spotting agent comprising a hydrophobically modified polycarboxylic acid, or a surfactant having a cloud point in water of less than about 60° C., or a polymer having a weight average molecular weight of greater than about 2000 and comprising a positive charge, or a mixture thereof; and

(b) a water soluble polymer that reduces phosphate scale formation, a compound that reduces carbonate scale formation, or both.

There generally is no limitation with respect to the type of hydrophobically modified polycarboxylic acid that may be used in this invention other than that the polycarboxylic acid can be used in a detergent composition that comprises a water soluble polymer. Such a hydrophobically modified polycarboxylic acid often has a weight average molecular weight of greater than about 175 and less than about 1.5 million, and preferably, greater than about 200 and less than about 1 million; and most preferably, greater than about 225 and less than about 750 thousand, including all ranges subsumed therein.

The preferred hydrophobically modified polycarboxylic acid which may be used in this invention comprises at least one structural unit of the formula:

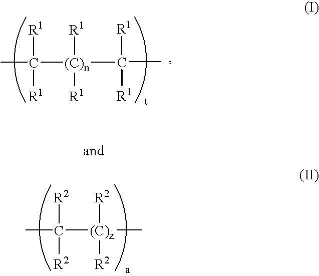

wherein each R¹ and R² are independently a hydrogen, hydroxy, alkoxy, carboxylic acid group, carboxylic acid salt, ester group, amide group, aryl, C₁₋₂₀ alkyl, C₂₋₂₀ alkenyl, C₂₋₂₀ alkynyl or a polyoxyalkylene condensate of an aliphatic group, n is an integer from about 0 to 8, z is an integer from about 1 to about 8, t is an integer from about 0 to about 2,000 and a is an integer from about 0 to about 2,000, with the proviso that a and t are not simultaneously 0 and at least one R¹ or one R² is a carboxylic acid group, or a salt thereof.

In a preferred embodiment, the hydrophobically modified polycarboxylic acid used in this invention comprises at least one structural unit represented by formula I (t≧1) with at least one R¹ as a carboxylic acid group (or salt thereof), and at least one structural unit represented by formula II (a≧1) with at least one R² group as a C₄₋₂₀ alkyl group or a C₈₋₃₀ ethoxylated condensate of an aliphatic group.

In a most preferred embodiment, however, the modified polycarboxylic acid used in this invention comprises structural units represented by formula I and structural units represented by formula II wherein a is from about 80% to about 120% of t, and at least two R¹ groups are carboxylic acid groups (or salts thereof) and at least one R² group is a methyl group and at least one R² group is a C₅ alkyl, and n is 0 and z is 1.

The hydrophobically modified polycarboxylic acids which may be used in this invention are typically prepared by reacting the desired precursors (sp² bonded monomers) under free radical polymerization conditions. Such polycarboxcylic acids are also commercially available from suppliers like Rohm & Haas and DuPont. A more detailed description of the types of hydrophobically modified polycarboxylic acids which may be used in this invention, including the process for making the same, may be found in U.S. Pat. No. 5,232,622, the disclosure of which is incorporated herein by reference.

The preferred and most preferred hydrophobically modified polycarboxylic acids are made available by Rohm & Haas under the names Acusol 820 and 460, respectively.

There is generally no limitation with respect to how much hydrophobically modified polycarboxylic acid that may be used in this invention other than the amount used results in a detergent composition. Typically, however, from about 0.1 to about 10.0, and preferably, from about 0.2 to about 7.0, and most preferably, from about 0.3 to about 5.0% by weight of the dishwashing composition is a hydrophobically modified polycarboxylic acid, based on total weight of the dishwashing composition, including all ranges subsumed therein.

The surfactant having a cloud point in water of less than about 60° C. typically enhances wetting properties of the glassware being cleaned. These nonionic surfactants can be broadly defined as surface active compounds with at least one uncharged hydrophilic substituent. A major class of nonionic surfactants are those compounds produced by the condensation of alkylene oxide groups with an organic hydrophobic material which may be aliphatic or alkyl aromatic in nature. The length of the hydrophilic or polyoxyalkylene radical which is condensed with any particular hydrophobic group can be readily adjusted to yield a water-soluble compound having the desired degree of balance between hydrophilic and hydrophobic elements. Illustrative examples of various suitable nonionic surfactant types are polyoxyalkylene condensates of aliphatic carboxylic acids, whether linear- or branched-chain and unsaturated or saturated, especially ethoxylated and/or propoxylated aliphatic acids containing from about 8 to about 18 carbon atoms in the aliphatic chain and incorporating from about 2 to about 50 ethylene oxide and/or propylene oxide units. Suitable carboxylic acids include “coconut” fatty acids (derived from coconut oil) which contain an average of about 12 carbon atoms, “tallow” fatty acids (derived from tallow-class fats) which contain an average of about 18 carbon atoms, palmitic acid, myristic acid, stearic acid and lauric acid.

Other nonionic surfactants having a cloud point of less than about 60° C. include polyoxyalkylene condensates of aliphatic alcohols, whether linear- or branched-chain and unsaturated or saturated, especially ethoxylated and/or propoxylated aliphatic alcohols containing from about 6 to about 24 carbon atoms and incorporating from about 2 to about 50 ethylene oxide and/or propylene oxide units. Suitable alcohols include “coconut” fatty alcohol, “tallow” fatty alcohol, lauryl alcohol, myristyl alcohol and oleyl alcohol. Preferred examples of such materials are provided by BASF Corporation as a series under the tradename Plurafac. Particularly preferred surfactants are Plurafac LF 301, Plurafac LF 403 and Plurafac SLF-18. Also included within this class of nonionic surfactants are epoxy capped poly(oxyalkylated) alcohols as described in WO 94/22800. A preferred example of this class of material is Poly-Tergent SLF 18B 45 made available by BASF Corporation.

Polyoxyethylene or polyoxypropylene condensates of alkyl phenols, whether linear- or branched-chain and unsaturated or saturated, containing from about 6 to 12 carbon atoms and incorporating from about 2 to about 25 moles of ethylene oxide and/or propylene oxide are other types of nonionic surfactants which may be used.

Other desired nonionic surfactants which may be used include polyoxyethylene-polyoxypropylene block copolymers having formulae represented as

HO(CH₂ CH₂O)_{a′}(CH(CH₃) CH₂O)b(CH₂ CH₂O)_{c}H

or

HO(CH(CH₃)CH₂O)_{d}(CH₂ CH₂O)ₑ(CH(CH₃) CH₂O)_{f}H

wherein a′, b, c, d, e and f are integers from 1 to 350 reflecting the respective polyethylene oxide and polypropylene oxide blocks of said polymer. The polyoxyethylene components of the block polymer constitutes at least about 10% of the block polymer. The material preferably has a molecular weight of between about 1,000 and 15,000, more preferably from about 1,500 to about 6,000.

These materials are well known in the art. They are available as a series of products under the trademark “Pluronic” and “Pluronic R”, from the BASF Corporation.

It is also noted herein that while the nonionic surfactants used in this invention typically have a cloud point of less than about 60° C., they preferably have a cloud point of less than about 50° C., and most preferably, less than about 45° C.

The surfactants having a cloud point in water of less than about 60° C. are typically present within the detergent composition at levels of at least 0.5 wt. %, preferably, 1-15 wt. %, and most preferably, 1.5 to 8 wt. %, based on the total weight of the detergent composition, including all range subsumed therein.

The polymer comprising a positive charge that may be used in this invention may be defined to mean an entity prepared from at least two monomeric units whereby at least one monomeric unit comprises a positive charge. There generally is no limitation with respect to the type of polymer comprising a positive charge that may be used in this invention other than that the positively charged polymer can be used in a dishwashing composition that comprises a water soluble polymer that reduces phosphate and/or carbonate scale formation. Such a polymer comprising a positive charge often has a weight average molecular weight of greater than about 2,000; and preferably, greater than about 3,000; and most preferably, greater than about 4,000.

The polymer comprising a positive charge which may be used in this invention is typically soluble or dispersible to at least the extent of 0.01% by weight in distilled water at 25° C. Such a positively charged polymer includes polymers in which one or more of the constituent monomers maintains a positive charge in solution over a portion of the pH range 2-11. A partial listing of the monomers which may be used to make the polymers in this invention are presented in “Water-Soluble Synthetic Polymers: Properties and Behavior, Volume II”, by P. Molyneux, CRC Press, Boca Raton, 1983, ISBN 0-8493-6136, the disclosure of which is incorporated herein by reference. Additional monomers can be found in the “International Cosmetic Ingredient Dictionary, 5th Edition”, edited by J. A. Wenninger and G. N. McEwen, The Cosmetic, Toiletry, and Fragrance Association, Washington D.C., 1993, ISBN 1-882621-06-9, the disclosure of which is incorporated herein by reference. A third source of such monomers can be found in “Encyclopedia of Polymers and Thickeners for Cosmetics”, by R. Y. Lochhead and W. R. Fron, Cosmetics & Toiletries, vol. 108, May 1993, pages 95-135, the disclosure of which is also incorporated herein by reference.

Often, preferred monomers useful to make the polymers comprising a positive charge in this invention may be represented structurally as ethylenically unsaturated compounds having the formula:

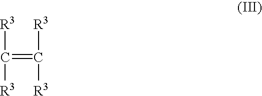

wherein each R³ is independently a hydrogen, derivatized hydroxy, C₁ to C₃₀ straight or branched alkyl group, aryl, aryl substituted C₁₋₃₀ straight or branched alkyl radical, or a polyoxyalkene condensate of an aliphatic moiety, a heteroatomic organic group comprising at least one positively charged group without a charged nitrogen, quaternized nitrogen atom or at least one amine group comprising a positive charge over a portion of the pH interval 2 to 11, with the proviso that at least one R³ group is a heteratomic organic group that has a positive charge without a charged nitrogen, a quaternized nitrogen atom group or an amine group comprising a positive charge. Such amine groups can be further delineated as having a pKₐ of about 6 or greater, as defined by R. Laughlin in “Cationic Surfactants, Physical Chemistry”, edited by D. N. Rubingh and P. M. Holland, Marcel Dekker, New York, 1991, ISBN 0-8247-8357-3. Moreover, it is further noted herein that salts of the monomers represented by formula I may also be used to make the polymers comprising the positive charge in this invention.

Examples of monomers comprising a positive charge as depicted by formula I include, but are not limited to, 2-vinylpyridine and its 2-vinyl N-alkyl quaternary pyridinium salt derivatives; 4-vinylpyridine and its 4-vinyl N-alkyl quaternary pyridinium salt derivatives; 4-vinylbenzyltrialkylammonium salts such as 4-vinylbenzyltrimethylammonium salt; 2-vinylpiperidine and 2-vinyl piperidinium salt; 4-vinylpiperidine and 4-vinylpiperidinium salt: 3-alkyl 1-vinyl imidazolinium salts such as 3-methyl 1-vinylimidazolinium salt; acrylamido and methacrylamido derivatives such as dimethyl aminopropylmethacrylamide, and methacrylamidopropyl trimethylammonium salt; acrylate and methacrylate derivatives such as dimethyl aminoethyl (meth)acrylate, ethanaminium N,N,N trimethyl 2-[(1-oxo-2 propenyl) oxy]-salt, ethanaminium N,N,N trimethyl 2-[(2 methyl-1-oxo-2 propenyl) oxy]-salt, and ethanaminium N,N,N ethyl dimethyl 2-[(2 methyl-1-oxo-2 propenyl) oxy]-salt. Also included among the monomers suitable to make the polymers with a positive charge employable in this invention are vinyl amine and vinylammonium salt; diallylamine, and methyldiallylamine.

Also, if desired, monomers containing cationic sulfonium salts such as 1-[3-methyl-4-(vinyl-benzyloxy)phenyl] tetrahydrothiophenium chloride may also be used to make the polymers comprising the positive charge of this invention.

There is no limitation with respect to the amount of polymer with a positive charge that may be used in this invention other than that the amount used results in a detergent composition. Typically, however, from about 0.1 to about 10.0, and preferably, from about 0.2 to about 7.0, and most preferably, from about 0.3 to about 5.0% by wt. of the dishwashing composition is a polymer comprising a positive charge, based on total weight of the detergent composition, including all ranges subsumed therein.

In general, the polymers comprising the positive charge which may be used in this invention are typically made commercially available from suppliers like Rhodia, Nalco and Rohm & Haas. The monomers used to make the polymers having a positive charge may be provided by suppliers like Aldrich and Sigma. Such polymers may also be prepared via conventional reactions which include free radical polymerizations.

As to the water soluble polymer that reduces phosphate scale formation, such a polymer often comprises at least one structural unit derived from a monomer having the formula:

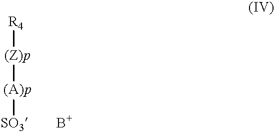

wherein R⁴ is a group comprising at least one sp² bond, Z is O, N, P, S, or an amido or ester link, A is a mono- or a polycyclic aromatic group or an aliphatic group and each p is independently 0 or 1 and B⁺ is a monovalent cation.

Preferably, R⁴ is a C₂ to C₆ alkene (most preferably ethene or propene). When R⁴ is ethenyl, Z is preferably amido, A is preferably a divalent butyl group, each t is 1, and B⁺ is Na⁺. Such a monomer is polymerized and sold as Acumer 3100 by Rohm & Haas.

Another preferred embodiment exists when the water soluble polymer is derived from at least one monomer with R⁴ as 2-methyl-2-propenyl, Z as oxygen, A as phenylene, each t as 1 and B⁺ as Na⁺, and at least one monomer with R⁴ as 2-methyl-2-propenyl, each t as 0 and B⁺ as Na⁺. Such monomers are polymerized and sold under the name Alcosperse 240 by Alco Chemical.

It is further noted herein that it is within the scope of this invention for all the polymers used to be a homopolymer or copolymer, including terpolymers. Furthermore, the polymers of this invention may be terminated with conventional termination groups resulting from precursor monomers and/or initiators that are used.

There is generally no limitation with respect to how much water soluble polymer that reduces phosphate scale formation is used in this invention as long as the amount used results in a detergent composition. Often, from about 0.5 to about 10.0, and preferably, from about 1.0 to 7.0, and most preferably, from about 1.5 to about 4.5% by weight water soluble polymer is used, based on total weight of the detergent composition, including all ranges subsumed therein. These water soluble polymers typically have a weight average molecular weight from about 1,000 to about 50,000.

Regarding the compounds that may be used to reduce carbonate scale formation, these include polyacrylates (and copolymers thereof) having a weight average molecular weight from about 1,000 to about 400,000. Such compounds are supplied by Rohm and Haas, BASF, and Alco Corp. Preferred copolymers include those derived from acrylic acid and maleic acid monomers like Sokalan CP5 and CP7 supplied by BASF, and Acusol 479N, supplied by Rohm & Haas. Copolymers of acrylic acid and methacrylic acid (Colloid 226/35), as supplied by Rhone-Poulenc, may also be used.

Other materials that may be used to reduce carbonate scale formation include phosphonate functionalized acrylic acid (Casi 773 as supplied by Buckman laboratories); copolymers of maleic acid and vinyl acetate, and terpolymers of maleic acid, acrylic acid and vinyl acetate (made commercially by Huls); polymaleates (like Belclene 200, as supplied by FMC); polymethacrylates, (like Tomal 850, as supplied by Rohm & Haas); polyaspartates; ethylene diamine disuccinate, organopolyphosphonic acids (and salts thereof) such as sodium salts of amino tri(methylenephosphonic acid), diethylene triamine penta (methylene phosphonic acid); hexamethylene diamine tetramethylene phosphonic acid; ethane 1-hydroxy-1,1-diphosphonic acid (HEDP); organomonophosphonic acids (and salts thereof) such as the sodium salt of 2-phosphono-1,2,4-butane tricarboxylic acid, all of which are sold under the Dequest line as supplied by Solutia. Phosphates, especially alkali metal tripolyphosphates may also be used as well as mixtures of the above-described materials. It has also been found that combinations of anti-scaling agents can be more effective at reducing calcium carbonate scale than individual anti-scaling agents themselves.

The materials that may be used to reduce carbonate scale formation typically make up from about 0.01% to about 10.0%, and preferably, from about 0.1% to about 6.0%, and most preferably, from about 0.2% to about 5.0% by weight of the total weight of detergent composition, including all ranges subsumed therein.

The compositions of this invention can comprise all manner of detergent builders commonly taught for use in machine dishwashing or other detergent compositions. The builders can include any of the conventional inorganic and organic water-soluble builder salts, or mixtures thereof and may comprise about 5 to about 90 wt. %, and preferably from about 10 to about 80 wt. % by weight of the detergent composition.

Typical examples of phosphorus-containing inorganic builders, when present, include the water-soluble salts, especially alkali metal pyrophosphates, orthophosphates and polyphosphates. Specific examples of inorganic phosphate builders include sodium, potassium, ammonium and alkanol ammonium tripolyphosphates, pyrophosphates and hexametaphosphates.

Suitable examples of non-phosphorus-containing inorganic builders, when present, include water-soluble alkali metal carbonates, bicarbonates, sesquicarbonates, borates, silicates, including layered silicates, metasilicates, and crystalline and amorphous aluminosilicates.

Organic detergent builders can also be used in the present invention. These are typically, but not restricted to, polycarboxylate materials. Within the scope of this invention polycarboxylate builders are those which have at least two carboxylate groups present in the compound and may be used either in the acidic form or as the neutralized soluble salt form. The alkali metal salts, such as lithium, sodium, potassium or the ammonium or alkanolammonium salts are the preferred forms.

Citrate derived builders, preferably their soluble alkali metal salts, most preferably the sodium salt are especially important with respect to machine dishwashing formulations.

Ether polycarboxylates are another important polycarboxylate builders. This class can be exemplified by the particularly preferred oxydisuccinate which has been revealed by Lamberti et. al. in U.S. Pat. No. 3,635,830 and by Berg et. al. in U.S. Pat. No. 3,128,287. Other examples of ether polycarboxylates include the “TMS/TDS” builders disclosed in U.S. Pat. No. 4,663,071. Cyclic ether polycarboxylates as disclosed in U.S. Pat. Nos. 4,158,635; 4,120,874; 4,102,903; 3,923,679; and 3,835,163 are also builders which can be used. Other classes of materials that fall into the category of ether polycarboxylates builders are the tartrate monoacetates, tartrate diacetates, oxydiacetates, tartrate monosuccinates, tartrate disuccinates and carboxymethyloxy succinates. 3,3-Dicarboxy-4-oxa-1,6-hexanedionates and the related compounds which are revealed in U.S. Pat. No. 4,566,984, mellitic acid and 3,5-dicarboxybenzoic acid are also suitable builders.

Another sub class of polycarboxylates are those derived by substitution onto an ammonia core or the aminopolycarboxylates. Examples within this class include ethylenediamine tetraacetate, methyl glycinediacetate, iminodisuccinate and nitrilotriacetate.

Polymeric polycarboxylates also serve as valuable building materials in machine dishwashing formulations. These include polycarboxylates such as polyacrylates, polymaleates, polyacetates, polyhydroxyacrylates, polyacrylate/polymaleate and polyacrylate/polymethacrylate copolymers, acrylate/maleate/vinyl alcohol terpolymers, and polyacetal carboxylates, and polyaspartates and mixtures thereof. Such carboxylates are described in U.S. Pat. Nos. 4,144,226, 4,146,495 and 4,686,062. Other examples of polymeric builders include oxidized starches and oxidized heteropolymeric polysaccharides. The acrylate/maleate copolymers and acrylate/maleate/vinyl alcohol terpolymers are especially preferred.

Alkali metal citrates, nitrilotriacetates, oxydisuccinates, methylglycinediacetates, iminodisuccinates, polyphosphonates organic builders are preferred.

In an especially preferred embodiment, citrate, iminodisuccinate or methylglycine diacetate is employed as the organic builder.

It is also within the scope of this invention to employ optional additives to the detergent compositions of this invention in addition to the materials described above.

Such optional additives which may be used in this invention include those comprising an antifoaming agent, including, for example, silicone antifoams, silicone oil, mono- and distearyl acid phosphates, mineral oil, and 2-alkyl and alcanol antifoam compounds. These antifoaming agents may be used in combination with defoaming surfactants. The detergent composition of this invention typically comprises from about 0.02 to 2.0% by weight of antifoaming agent when use of the same is desired.

Other optional additives which may be used in the detergent composition of this invention include anti-tarnishing agents. Such anti-tarnishing agents typically comprise benzotriazole, 1,3 N-azoles, isocyanuric acid, purine compounds, and mixtures thereof.

Buffering agents may also be optionally used and they typically make up from about 1.0 to about 25.0% by weight of the total weight of the detergent composition. Agents which may be used are well known and include potassium and sodium salts of disilicate, bicarbonate, carbonate, sesquicarbonate, citrate, phytic acid, and mixtures thereof. Conventional detergent surfactants may also (optionally) be employed in this invention and these include anionic surfactants like alkyl sulfates and sulfonates as well as fatty acid ester sulfonates. Particularly, salts of (i.e., sodium, potassium, ammonium, and substituted ammonium salts such as mono-, di- and triethanolamine salts) anionic sulfates, sulfonates, carboxylates, and sarcosinates may be used. Other optional anionic surfactants which may be used include isothionates, like acyl-isothionates, N-acyltaurates, fatty acid amides of methyl tauride, alkyl succinates and sulfocsuccinates; mono esters of sulfosuccinate; and diesters of sulfosuccinate. These types of surfactants often make up from about 0.0% to about 10.0% by weight of the total weight of the dishwashing composition.

Other optional additives which may be used with the preferred embodiments of this invention include well known items such as perfumes, dispersants, colorants, fillers, thickeners, structuring agents, lime soap dispersants, inert organic molecules, enzyme stabilizers, sequestrants, non-encapsulated bleaches, bleach scavengers, and protective agents for decorative ware. Especially preferred optional additives which may be used in this invention (i.e., within the core of the particle, detergent composition, or both) include polyacrylic acid based binders and dispersants (e.g., sold under the Sokalan name by BASF); heat sinks like boric acid or citric acid monohydrate (as described in U.S. Pat. No. 5,858,945); anionic surfactants like the alkylsulfonates made available from Clariant under the name Hostapur, and described in U.S. Pat. No. 5,480,577. Such additives, collectively, do not normally make up more than about 20.0% by weight of the total weight of the detergent composition.

When preparing the detergent composition (e.g., dishwashing composition) of this invention, the desired materials are mixed, in no particular order, and typically under conditions of ambient temperature and atmospheric pressure.

When washing kitchenware with the detergent composition of this invention, soiled kitchenware is typically placed in a conventional domestic or commercial dishwashing machine as is the detergent (i.e., dishwashing) composition of this invention (in no particular order). The dishwashing composition of this invention then dissolves in the water of the dishwasher to wash the kitchenware. The typical dishwashing cycle is from about 10 minutes until about 60 minutes and the typical temperature of the water in the dishwasher is from about 40° C. to about 70° C. The kitchenware resulting from the above-described cleaning method is clean and has an excellent glass appearance (i.e., substantially free of film and spots). Such results are unexpectedly obtained even when hard water is used, in the absence of rinse aid compositions. Moreover, the particles having a core and clad as described herein, are able to unexpectedly provide their characteristic benefits in the wash cycle because the clad prevents them from dropping or sinking out of the wash water and into the sump or drainage system of the dishwashing machine.

When marketing the superior detergent composition having the particle of this invention, the detergent composition may take any form. It is preferred, however that the composition is a paste, slurry, liquid, gel, powder, tablet or block and sold in a package with directions to add the dishwashing composition to the dishwashing machine as a 3-in-I product. In a most preferred embodiment, the detergent composition is in the form of a paste, slurry or powder filled sachet. The sachet may be water permeable, water dispersible or water soluble. Preferred sachets are made of polyvinyl alcohol, polyethylene oxide and methyl cellulose. Such materials are known and described, for example in U.S. Pat. No. 5,294,361. Thus, a dishwasher is charged with the detergent composition of this invention without having to add to the dishwasher conventional rinse aid compositions and sodium chloride to regenerate the water softener unit.

The following examples are provided to facilitate an understanding of the present inventions. The examples are not intended to limit the scope of the inventions as described in the claims.

### EXAMPLE 1

A batch of wax encapsulated PAP particles were prepared according to the method described in U.S. Pat. No. 5,200,236. The capsules had the following formula:

| Component | % of formula |
|---|---|
| PAP | 71.0 |
| Citric acid monohydrate | 8.5 |
| Sokalan CP 45 | 4.3 |
| Hostapur SA360 | 0.9 |
| (Surfactant) | |
| Moisture | 0.4 |
| Paraffin wax clad | 15 |
| (Boler 1397) | |

### EXAMPLE 2

1.0-1.5 g. of PAP particles and modified PAP particles were placed in water in a glass dish and the particles that floated were removed, dried and weighed. Similarly, those that sank were removed, dried and weighed.

The following particles were evaluated with the percent floating indicated.

| | % Floating |
|---|---|
| PAP | 0 |
| Modified PAP from Example 1 (15% Wax) | 95-100 |
| Modified PAP with 50% wax coating | 100 |

The results unexpectedly show that bleach particles coated with about 15% by weight clad float in a manner which is substantially similar to conventional particles having at least 50% by weight clad.

### EXAMPLE 3

A powder dishwashing composition having the following formula was

| Component | % of formula |
|---|---|
| Sodium citrate | 30% |
| Sokalan CP45 | 4% |
| Sodium bicarbonate | 48.5% |
| PAP wax capsules | 6.15% |
| (as prepared in Example 1) | |
| Enzyme | 5.7% |
| Benzotriazole | 0.05% |
| Surtactant | 1.5% |
| Perfume | 0.02% |

### EXAMPLE 4

The superior bleaching performance of PAP modified within the scope of the invention over the performance of the unmodified PAP was observed as follows. The bleach particles of Example 1 as well as unmodified bleach (PAP) samples and a bleach samples with 50% by weight clad were added to the base formulation described in Example 3. Bleach was dosed at 6.6 ppm available oxygen in all cases.

| | |
|---|---|
| Sample 1 | Unencapsulated PAP granules |
| Sample 2 | encapsulated PAP—50% wax coating |
| Sample 3 | encapsulated PAP—15% wax coating |

Cups were stained with tea and washed in a Bauknecht dishwashing machines with Samples 1-3 above. The cups were removed and visually evaluated for tea stains on a 0 to 5 scale with 0 meaning no stain and 5 meaning heavily stained with the following results:

| Sample | Residual tea stain |
|---|---|
| Sample 1 | 3 |
| Sample 2 | 1.5 |
| Sample 3 | 0 |

The results indicate that modifying the bleach component (Sample 3) within the scope of the invention delivered improved bleaching over that obtained with unmodified bleach. Moreover, the wax coating of the encapsulates at 15 wt. % of the particles (Sample 3) unexpectedly exhibited improved performance over the particles having a 50% wax coating (Sample 2).

### EXAMPLE 5

In Example 4, it was shown that improved bleaching can be obtained by modifying the bleach within the scope of the invention. It is reasonable to assume that the additional ingredients required to effect the modification play no role by themselves in the improved bleaching because the modification in itself will tend to retard dissolution into the wash water.

In order to show that a reduction in mechanical loss via the modification is the cause of the improved bleaching, the bleach yield in the bulk solution of the dishwashing machine during a short cycle was evaluated for unmodified bleach and bleach with a 15% coating of wax. Bleach was dosed at 6.6 ppm available oxygen in all cases. Data is expressed as percent theoretical maximum of bleach.

The results are shown below.

| | 15% Wax modified | PAP unmodified |
|---|---|---|
| Machine Type | (clad) PAP | (no clad) |
| Bosch | 90 | 42 |
| Bauknecht | 82 | 62 |
| Electrolux | 78 | 10 |

In all cases, bleach yields from the bleach modified within the scope of the invention were higher and more consistent than those from unmodified bleach. This indicates that modification of the particle within the scope of the invention helps prevent mechanical loss.

### EXAMPLE 6

Bleach titration in the bulk wash solution and in the solution close to a sump (lowest point in the machine) show very significant differences in behavior of modified bleach vs. unmodified bleach. Experiments were run in the Bosch/Quik cycle with no soils present. Data is expressed as percent theoretical maximum of bleach.

% theoretical maximum of bleach

| | |
|---|---|
| 15% wax | PAP |
| modified | unmodified |
| (clad) PAP | (no clad) |

| Time in wash | Wash | Sump | Wash | Sump |
|---|---|---|---|---|
| 4 min | 40 | 40 | 45 | 85 |
| 8 min | 80 | 85 | 45 | 180 |

This demonstrates that modification of the bleach (as described in this invention) unexpectedly results in less mechanical loss, and more even distribution of the bleach throughout the wash water.

We claim:

1. A detergent composition comprising at least one particle with:
a) a core which is poorly soluble in water and which has a density greater than about 1 g/cc; and
b) a clad surrounding the core the clad having a density of less than about 1 g/cc,
wherein the clad makes up from about 0.01% to less than about 20.0% by weight of the particle and the core has an approximate diameter from about 50.0 to about 5000 microns.

2. The detergent composition according to claim 1 wherein the detergent composition is a dishwashing composition.

3. The detergent composition according to claim 1 wherein the detergent composition is a paste, slurry, gel, liquid, powder, block or tablet.

4. The detergent composition according to claim 1 wherein the detergent composition is a paste, slurry or powder, and the paste, slurry or powder is in a sachet.

5. The detergent composition according to claim 4 wherein the sachet is water soluble.

6. The detergent composition according to claim 1 wherein the detergent composition further comprises:
(a) an anti-spotting agent comprising a hydrophobically modified polycarboxylic acid, or a surfactant having a cloud point in water of less than about 60° C., or a polymer having a weight average molecular weight of greater than about 2000 and comprising a positive charge, or a mixture thereof; and
(b) a water soluble polymer that reduces phosphate scale formation, a compound that reduces carbonate scale formation, or both.

7. The detergent composition according to claim 1 wherein the core is substantially free of material used to make the clad.

8. The detergent composition according to claim 1 wherein the clad has a thickness that is from about (0.01-0.15)r, where r is the approximate radius of the core.

9. The detergent composition according to claim 1 wherein the core comprises a bleaching agent or enzyme.

10. The detergent composition according to claim 1 wherein the core comprises PAP.

11. A method for washing kitchenware comprising the steps of:
(a) loading a dishwashing machine with kitchenware;
(b) contacting the kitchenware with a dishwashing composition comprising at least one particle with:
(i) a core which is poorly soluble in water and which has a density greater than about 1 g/cc; and
(ii) a clad surrounding the core the clad having a density of less than about 1 g/cc.

12. The method for washing kitchenware according to claim 11 wherein the dishwashing composition is a paste, slurry, gel, liquid, powder, block or tablet.

13. The method for washing kitchenware according to claim 11 wherein the dishwashing composition is a paste, slurry or powder, and the paste, slurry or powder is in a sachet.

14. The method for washing kitchenware according to claim 13 wherein the sachet is water soluble.

15. The method for washing kitchenware according to claim 11 wherein the core is substantially free of material used to make the clad.

16. The method for washing kitchenware according to claim 11 wherein the clad has a thickness that is from about (0.01-0.15)r, where r is the approximate radius of the core.

17. The method for washing kitchenware according to claim 1 wherein the core comprises a bleaching agent or enzyme.

18. A kit comprising:
(i) a paste, slurry or powdered detergent composition comprising at least one particle with:
a) a core which is poorly soluble in water and which has a density greater than about 1 g/cc;
b) a clad surrounding the core, the clad having a density of less than about 1 g/cc; and
(ii) instructions to use the detergent composition in a dishwasher and without a rinse aid.

19. The kit according to claim 18 wherein the paste, slurry or powdered detergent composition is in a water soluble sachet.

20. The kit according to claim 18 wherein the clad has a thickness that is from about (0.01-0.15)r, where r is the approximate radius of the core.

21. The kit according to claim 18 wherein the kit further includes instructions not to use salt.
